(19) United States
(12) Patent Application Publication
(10) Pub. No.: US 2005/0184511 A1
(43) Pub. Date: Aug. 25, 2005

(54) Water supply tube and riser assembly and related method

(75) Inventor: Charles R. Harrold, Walla Walla, WA (US)

Correspondence Address: NIXON & VANDERHYE, PC, 901 NORTH GLEBE ROAD, 11TH FLOOR, ARLINGTON, VA, 22203, US

(73) Assignee: Nelson Irrigation Corporation, Walla Walla, WA (US)

(21) Appl. No.: 10/781,643

(22) Filed: Feb. 20, 2004

(51) Int. Cl. F16L 39/00

(52) U.S. Cl. 285/133.3

(57) ABSTRACT

A process for installing a plastic connector bushing in a plastic water supply tube includes a) cutting a hole of predetermined diameter in the water supply tube; b) locating the connector bushing in the hole, the connector bushing having an upper radial flange, and wherein a metal washer is interposed between an underside of the radial flange and an area of the water supply tube surrounding the hole; and c) applying energy to the metal washer sufficient to cause melting of respective facing surface portions of the radial flange and water supply tube to thereby form a bonded joint between the connector bushing and the water supply tube. A corresponding water supply tube or riser assembly includes an irrigation tube for supplying water to at least one supply line or riser assembly, the irrigation tube having at least one hole formed therein with a connector bushing inserted within the hole. The connector bushing has a radial flange bonded to a surface of the irrigation tube surrounding the hole, with a metal washer interposed between the radial flange and the surface. A tubular connector is inserted within the connector bushing, and a supply line or riser has one end inserted within the tubular connector.

### BACKGROUND OF THE INVENTION

This invention relates to irrigation apparatus and, specifically, to hardware for withdrawing water at predetermined intervals from irrigation tubing for supply to individual sprinkler heads, lateral supply lines, drip tape, drip tube or the like.

Typically, withdrawing water from irrigation tubing, and especially polyethylene tubing, has involved punching a hole in the supply tube and installing a barbed connector into the tube. This step has been followed by inserting a flexible supply line or rigid riser into the connector. This practice has significant drawbacks, however. For example, once the barbed connector has been inserted into the tube, removal is difficult if not practically impossible, and the extent of penetration into the supply tube may impede coiling of the tube for storage. Problems have also occurred with leakage and with retention of the connector under high pressures typically encountered in a primary supply line. As the diameter of the tube increases, the above drawbacks are magnified. For example, flow demand at higher rates requires greater areas of penetration by the connector that, in turn, not only impacts the design of the connector barb, but also impedes flow.

### BRIEF DESCRIPTION OF THE INVENTION

The present invention seeks to alleviate these problems by initially bonding a connector bushing to the tubing that provides a more reliable fit and that has a more compact profile interiorly of the supply tube.

In one exemplary embodiment, holes are pre-drilled or punched in the irrigation supply tube and connector bushings are inserted into the holes and bonded to the tube. A bonding process has been developed that is particularly effective with polyethylene, a material often used for irrigation tube and connectors. More specifically, in the illustrated embodiment, a metal “washer,” preferably made in the form of wire mesh, is interposed between the irrigation tube and the underside of a radial flange on the connector bushing. After insertion of the bushing into the hole, heat is applied to the metal washer sufficient to cause adjacent, facing surfaces of the tube and bushing to melt, bonding together through the wire mesh. This is followed immediately by the application of compressive pressure while the bond cools, thereby creating a more effective and reliable bond between the two components. This bonding process eliminates the need for internal barbs, and thereby permits use of a radially shorter connector bushing that has a reduced impact on flow through the supply tube.

In the exemplary embodiment, the connector bushing is formed with a tapered through-bore, and the supply line or riser connector has a correspondingly tapered outer surface on a lower portion thereof, with a rib or bead at the lower edge facilitating a snap-in installation. An intermediate annular shoulder on the connector rests on the bushing while an upper portion of the connector is counterbored to receive a supply line or riser tube component. Various connector configurations may be utilized, but the lower portions of each are preferably tapered as described above, with a snap ring about their respective lower edges.

Accordingly, in one aspect, the invention relates to a process for installing a plastic connector bushing in a plastic water supply tube comprising a) cutting a hole of predetermined diameter in the water supply tube; b) locating the connector bushing in the hole, the connector bushing having an upper radial flange, and wherein a metal washer is interposed between an underside of the radial flange and an area of the water supply tube surrounding the hole; and c) applying energy to the metal washer sufficient to cause melting of respective facing surface portions of the radial flange and water supply tube to thereby form a bonded joint between the connector bushing and the water supply tube.

In another aspect, the invention relates to an irrigation water supply tube and supply line or riser assembly comprising an irrigation tube for supplying water to at least one flexible supply line or rigid riser, the irrigation tube having at least one hole formed therein with a connector bushing inserted within the hole, the connector bushing having a radial flange bonded to a surface of the irrigation tube surrounding the hole, with a metal washer interposed between the radial flange and the surface; a flexible supply line or rigid riser connector inserted within the connector bushing; and a supply line or riser tube having one end inserted within the supply line or riser connector.

The invention will now be described in detail in connection with the drawings identified below.

### BRIEF DESCRIPTION OF THE DRAWINGS

FIG. 1 is a side elevation of an irrigation tube and supply line or riser assembly in accordance with the exemplary embodiment of the invention;

FIG. 2 is a partial perspective view of a hole cutting station in an irrigation and riser assembly apparatus;

FIG. 3 is a partial perspective view of heating and pressure applying components in the irrigation tube and riser assembly apparatus;

FIG. 4 is a partial perspective view of the apparatus shown in FIG. 3, but with pressure being applied to the connector bushing;

FIG. 5 is a partial perspective view of another embodiment of the invention, illustrating the manner in which heat is applied by a portable apparatus;

FIG. 6 is a plan view of a metal washer used in the irrigation tube and riser assembly shown in FIG. 1;

FIG. 7 is a plan view of an alternative metal washer utilizing diametrically opposed tabs for the application of heat energy;

FIG. 8 is a side elevation of a connector bushing in accordance with the first exemplary embodiment of the invention;

FIG. 9 is a side elevation of a riser connector used in the irrigation tube and riser assembly shown in FIG. 1; and

FIG. 10 is a side elevation of an alternative riser connector.

### DETAILED DESCRIPTION OF THE INVENTION

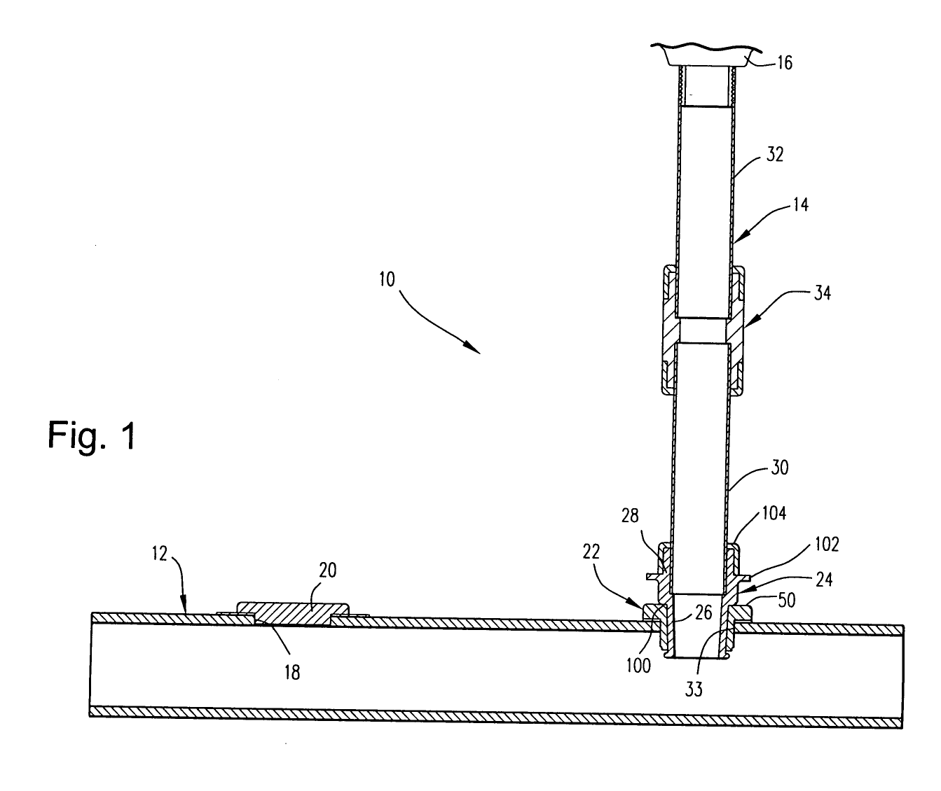

With reference to FIG. 1, a sprinkler water supply tube and supply line or riser assembly 10 in accordance with one exemplary embodiment of the invention includes a water supply tube 12 and at least one supply line or riser assembly 14 that supplies water to any sprinkler head or other irrigation component 16 of any conventional type. The supply tube 12 may be round or oval, and is typically formed of polyethylene. Connector bushing locations can be determined in the manufacturing plant and/or the field by cutting or drilling a plurality of axially spaced holes 18 in the tube 12. Any leaks or damaged holes 18 can be closed by bonding caps 20 over the holes as necessary. Holes 33 that will be used to mount supply line or riser assemblies are fitted with connector bushings 22. The process for bonding caps 20 and bushings 22 to the supply tube 12 is identical, and will be described below only in connection with the bushings 22.

A tubular connector 24 is designed to have one end 26 press-fit into engagement in the bushing 22. The opposite end 28 of fitting 24 receives one end of a flexible tubular component 30 of the riser assembly 14. The tubular component 30 may be used alone or coupled or spliced to a second tubular component 32 via coupler 34 if desired. It will be understood, that the components 30 and 32 may also be in the form of a flexible water supply line with a sprinkler or other irrigation component attached to the remote or distal end of the flexible supply line.

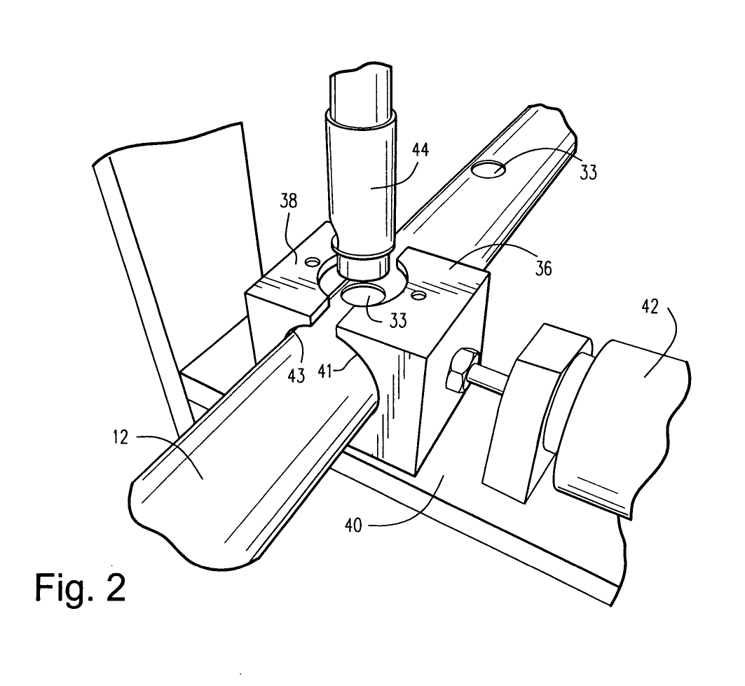

More specifically, and with reference to FIG. 2, the supply tube 12 may be provided with the plurality of axially spaced holes 33 at the manufacturing stage. In this case, downstream of the tube extrusion die (not shown), the cooled supply tube 12 may be held between a pair of clamp blocks 36, 38 supported on a traveling machine frame component 40, one of which may be stationary and the other of which may be moved into engagement with the tube 14 by e.g., a hydraulic cylinder 42. Blocks 36, 38 have facing surfaces 41, 43 that preferably conform to the curvature of the tube. A boring or drilling tool 44 may then be engaged with the tube 12 in an area between the clamp blocks 36, 38 to form the hole 33. Similar holes 33 may be drilled or otherwise cut at predetermined regular intervals, or in a non-regular pattern in accordance with specific customer requirements.

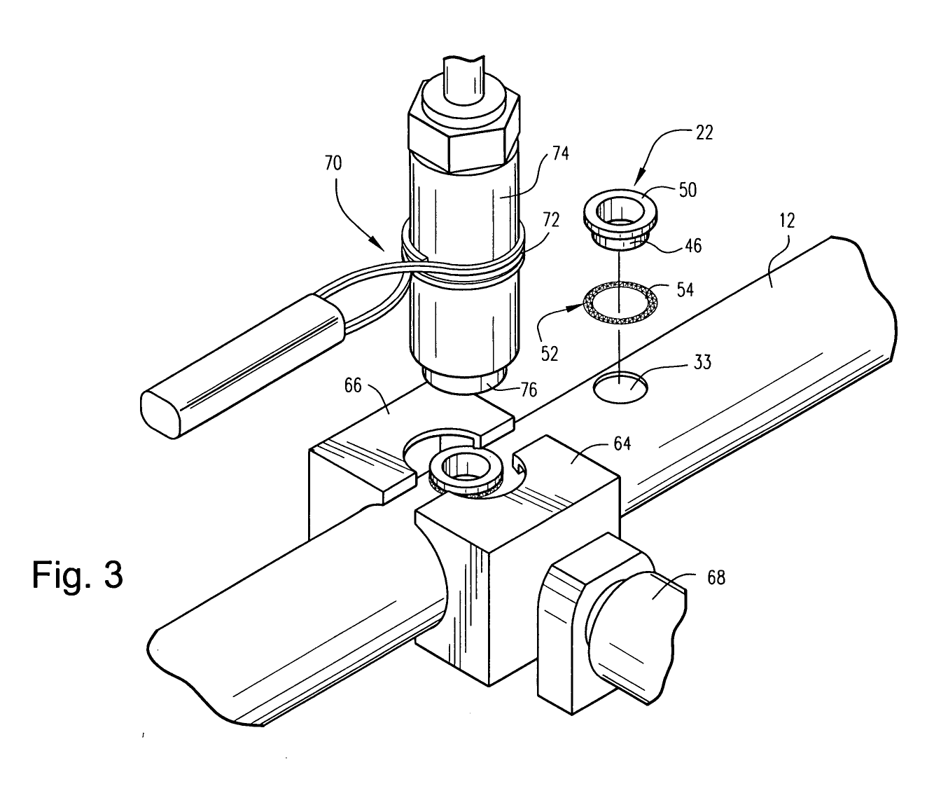

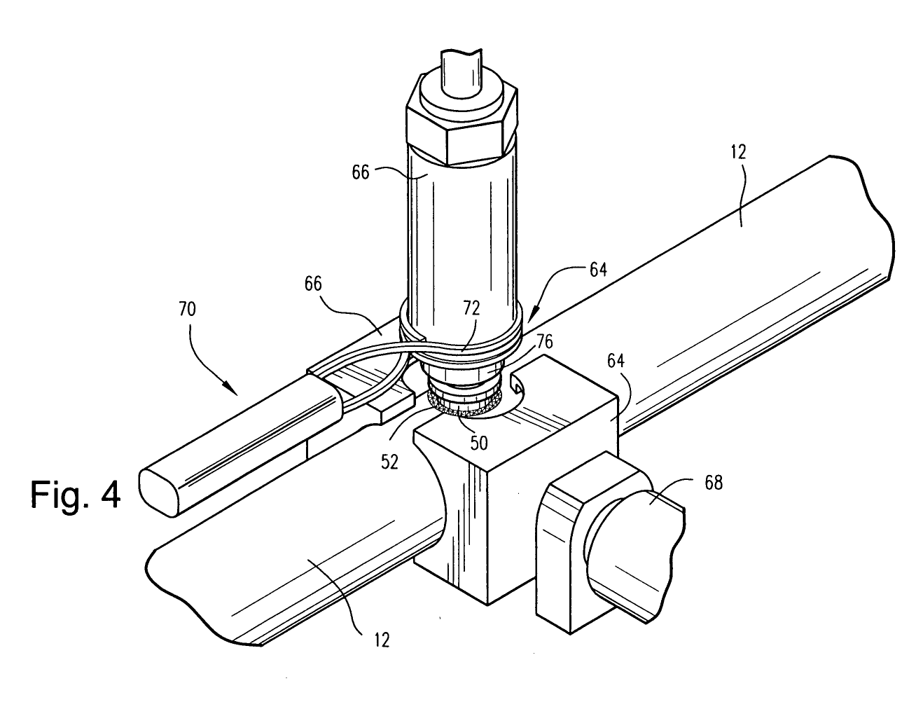

In the manufacturing stage, after the holes 33 are cut, the tube 12 (FIG. 2) moves to a subsequent station, shown in FIGS. 3 and 4, where connector bushings 22 are installed (manually or automatically), within all of the holes 33. Those holes 18 that are not to be fitted with supply line or riser assemblies may be closed by caps 20 (FIG. 1). The bushing 22, best seen in FIG. 8, also made of polyethylene, has a round body portion 46 having an outer diameter of, for example, 0.75 inch. The inner end 48 of the body portion is formed with an outer diameter of 0.72 inch for an axial distance of 0.03 inch. The outer end is formed with a radial flange 50 having an outer diameter of about 1.10 inch. The bushing has an internal bore 52 that tapers inwardly from the outer end to the inner end of the bushing, at about a 2° angle, with an inner diameter of about 0.63 inch at the upper or outer edge of the flange 50, tapering to an inner diameter of about 0.59 inch at the lower or inner edge of the inner end 48 of the bushing. It will be appreciated that the dimensions may vary for different applications.

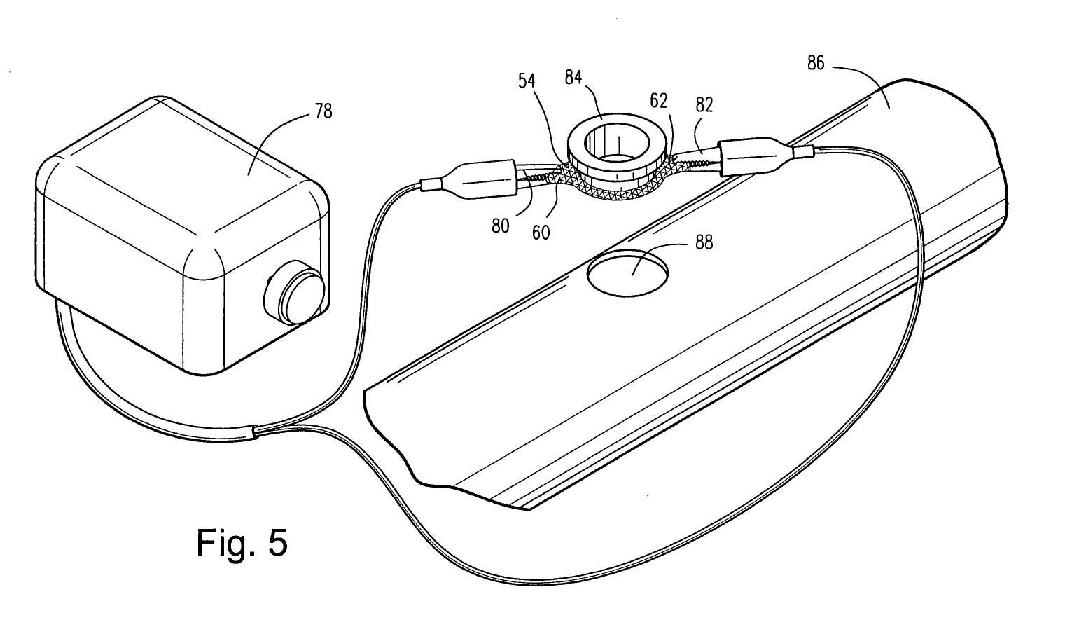

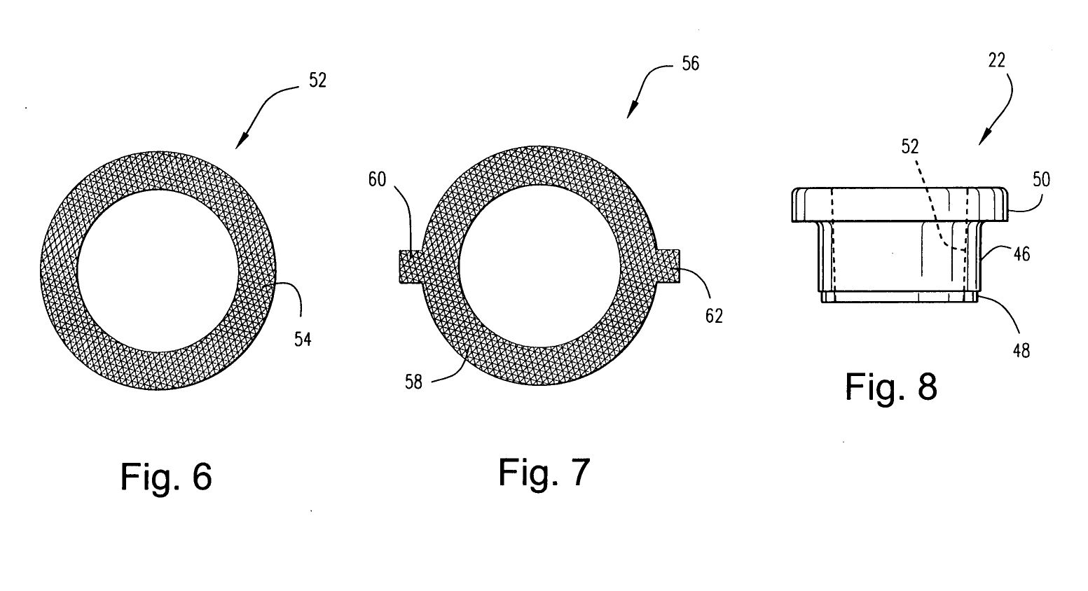

Returning to FIG. 3, between the underside of the flange 50 and the tube 12, there is placed a metal “washer” 52 having a uniform annulus 54 that is sized to fit about the body portion 46 and to conform to the shape and size of the radial flange 50. The metal washer 52 is preferably constructed of #20 wire mesh stainless steel, and may have a uniform annulus configuration as best seen in FIG. 6. Alternatively, the washer 56 may have the configuration shown in FIG. 7. In this embodiment, the washer 56 has an annulus 58 and a pair of diametrically opposed, radially outwardly directed tabs 60, 62 that serve as application points for resistive heating clips or the like as described further below in connection with FIG. 5. In these two exemplary embodiments (FIGS. 6 and 7), washers 52, 56 may have outer diameters of about 1.5 inches and inner diameters of about 0.75 inch. Here again, sizes may be adjusted as needed.

FIGS. 3 and 4 illustrate an in-plant arrangement, downstream of the station shown in FIG. 2, for induction heating and bonding of the bushing 22 and metal washer 54 to the tube 14. As in the hole cutting station, clamp blocks 64, 66, in operative association with a hydraulic cylinder 68 are used to hold the tube 14 stationary while the bushing 22 is installed and bonded. In this regard, the washer 52 is located adjacent the underside of the radial flange 50 and these components are located, preferably automatically, in a respective hole 33. Once in place, heat energy is applied via unit 70 that includes induction coils 72 that are moved down over the barrel 74 of unit 70 into close adjacency with the metal screen washer 52 (FIG. 4). These coils surround the radial flange 50 and metal washer 54 and, upon the suitable application of heat to the metal screen washer 52, facing surfaces of the flange 50 and tube 14 (i.e., the underside of flange 50 and an annular ring area of the tube 14 about the hole 33) will melt to form an effective bond through the wire mesh of the metal washer 52. Once the melting occurs, pressure is applied via cylinder 76 to press the bushing 22 against the washer 52 and tube 14 to thereby insure a good bond. In alternative arrangements, RF, infrared, or electromagnetic energy may be used as a source of heat energy for heating the washer 52.

FIG. 5 illustrates an alternative field installation where a washer 56 (as shown in FIG. 7) is utilized with a resistive heating unit 78 (powered, e.g., by a DC battery) and “alligator” clips 80, 82 that attach to the tabs 60, 62. While the bushing 84 is shown outside the tube 86 in FIG. 5 for ease of understanding, it will be understood that heat energy is not applied until the bushing 84 is located into the hole 88 in the tube 86.

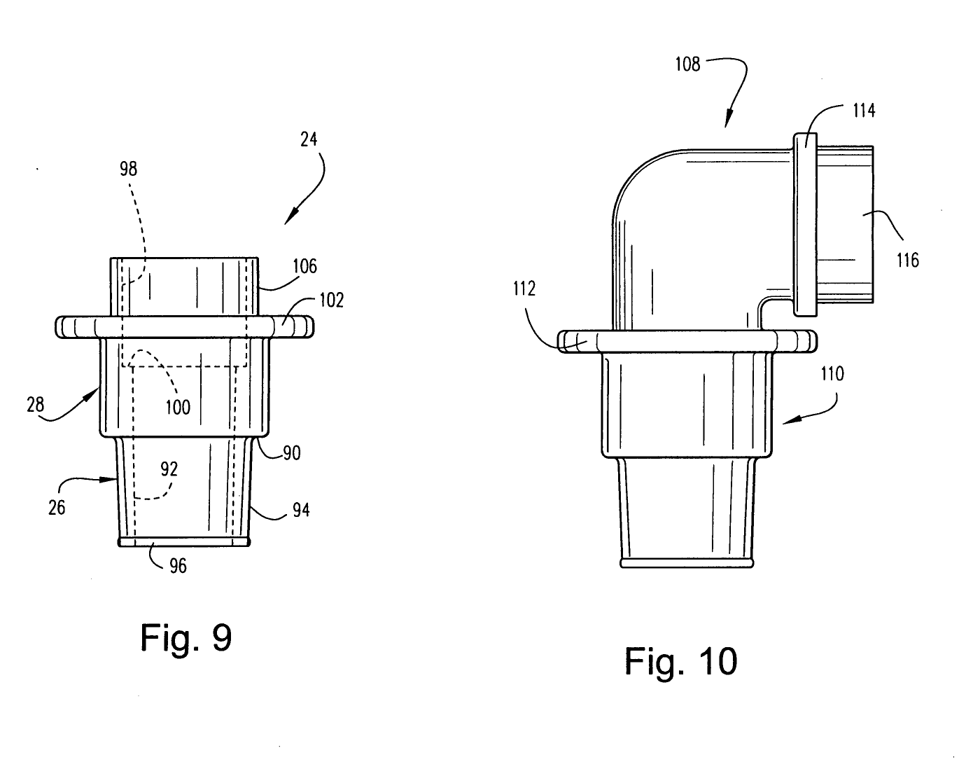

FIGS. 9-11 illustrate various connector fittings that may be installed in the bushing 22 (FIG. 1) for subsequent reception of a flexible supply line or rigid riser tube 30 (FIG. 1). FIG. 9 illustrates the tubular connector 24, also shown in FIG. 1. The connector 24 is formed with a lower end 26 and an upper end 28 separated by a radial shoulder 90 that seats on the top surface of the radial flange 50 (FIG. 1) at the upper end of the bushing 22 (FIG. 1). The lower end portion 26 has a first inner diameter portion 92 of about 0.46 inch, and a tapered outer surface 94 that reduces in diameter downwardly and inwardly at about a 2° angle, substantially conforming to the tapered interior of the bushing 22. An annular ring or bead 96 projects radially from the lower edge of the bushing and is adapted to snap beyond the lower edge of the bushing. The uniform inner bore extends upwardly into the upper portion 28 where the diameter is increased via a counterbore 98 having a uniform diameter of about 0.58 inch and terminating at the shoulder 100. An external radial flange 102 is located intermediate the upper portion 28, providing a seat for a compression style or cone-shaped orifice cap 104 (FIG. 1) that may be threaded, snapped or sonically welded over the reduced diameter portion 106 of the upper portion 28 prior to the flexible tubular component 30 being inserted through the cap 104 into the counterbore 98 (see FIG. 9).

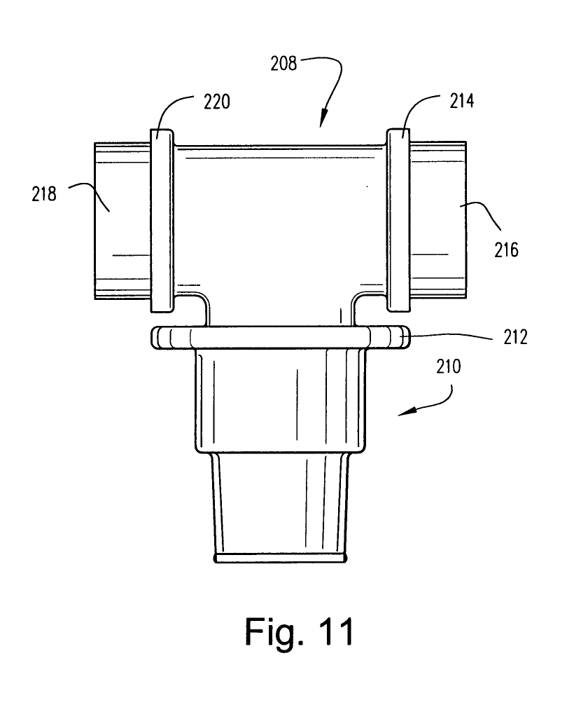

FIG. 10 illustrates another connector 108 that is formed with a lower portion 110 substantially the same as the lower portion of connector 24. Above the radial flange 112 (similar to flange 102 in FIG. 9), the connector is formed with a 90° bend and is especially adapted for use with a flexible supply line. A second radial flange 114 serves as a seat for a cap, similar to cap 104 (FIG. 1) applied over the distal end 116 of the connector. The internal and external geometry of distal end 116 is substantially the same as that of the end portion 106 of connector 24.

FIG. 11 illustrates yet another connector designed especially for use with a flexible supply line. Here, the “elbow” configuration of the connector in FIG. 10 is modified to produce a “T” fitting where the lower portion 210 of connector 208 is identical to connector 108 below radial flange 212, but the connector now extends in two opposite directions at an angle of 90° relative to the lower portion 210 of the connector. Thus, the connector is designed to accept flexible supply lines at opposite remote ends 216, 218 with radial flanges 214 and 220 serving as seats for caps (similar to cap 104 in FIG. 1) applied over the remote ends 216, 218 prior to insertion of the supply lines.

It will be appreciated that the invention is suitable and applicable for both in-plant manufacturing as well as in-the-field modifications to existing irrigation supply tubes. The equipment necessary to carry out the various cutting and bonding steps is readily available in portable form for in-the-field work.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A process for installing a plastic connector bushing in a plastic water supply tube comprising:
a) cutting a hole of predetermined diameter in said water supply tube;
b) locating the connector bushing in the hole, the connector bushing having an upper radial flange, and wherein a metal washer is interposed between an underside of the radial flange and an area of the water supply tube surrounding the hole; and
c) applying energy to the metal washer sufficient to cause melting of respective facing surface portions of the radial flange and water supply tube to thereby form a bonded joint between the connector bushing and the water supply tube.

2. The method of claim 1 wherein the connector bushing and water supply tube are constructed of polyethylene.

3. The method of claim 1 wherein the metal washer is constructed of stainless steel wire mesh.

4. The method of claim 1 wherein the energy applied in step c) is in the form of RF energy.

5. The method of claim 1 wherein the energy applied in step c) is in the form of an electromagnetic field.

6. The method of claim 1 wherein the energy applied in step c) is resistance heating.

7. The method of claim 6 wherein the resistance heating is generated by a DC battery.

8. The method of claim 1 including:
d) applying pressure to the bonded joint.

9. The method of claim 1 wherein the metal washer is formed with a pair of outwardly extending tabs for facilitating application of energy in step c).

10. The method of claim 3 wherein the metal washer is formed with a pair of outwardly extending tabs for facilitating application of energy in step c) of claim 1.

11. The method of claim 3 wherein the hole and the metal washer have diameters of about 0.75 inch.

12. The method of claim 1 and further comprising:
d) installing a tubular supply line or riser connector in said connector bushing.

13. The method of claim 1 wherein said connector bushing is formed with a tapered through-bore.

14. The method of claim 12 wherein said connector bushing is formed with a tapered through-bore.

15. The method of claim 14 wherein said tubular supply line or riser connector has a correspondingly tapered exterior surface for engagement with said tapered through-bore.

16. The method of claim 15 wherein a lower edge of said tubular supply line or riser connector is formed with a radial bead of larger diameter than a diameter of a lowermost edge of said connector bushing, and further wherein, during step d) of claim 12, said radial bead is pushed beyond the lowermost edge of said connector bushing.

17. The method of claim 15 and further comprising inserting one end of a supply line or riser into said tubular supply line or riser connector, and wherein a sprinkler or other irrigation product is attached to an opposite end of said supply line or riser.

18. The method of claim 12 wherein said connector includes a 90° elbow.

19. The method of claim 12 wherein said connector is substantially T-shaped.

20. An irrigation water supply tube and supply line or riser assembly comprising:
an irrigation tube for supplying water to at least one flexible supply line or rigid riser, said irrigation tube having at least one hole formed therein with a connector bushing inserted within said hole, said connector bushing having a radial flange bonded to a surface of said irrigation tube surrounding said hole, with a metal washer interposed between said radial flange and said surface; a tubular connector inserted within said connector bushing; and a flexible supply line or rigid riser having one end inserted within said tubular connector.

21. The assembly of claim 20 wherein said connector bushing is formed with a tapered through-bore; and wherein said tubular connector has a correspondingly tapered exterior surface for engagement with said tapered through-bore.

22. The assembly of claim 21 wherein a lower edge of said tubular connector is formed with a radial bead of larger diameter than a diameter of a lowermost edge of said connector bushing, and further wherein, during step d) of claim 12, said radial bead is pushed beyond the lowermost edge of said connector bushing.

23. The assembly of claim 20 and further comprising an irrigation component attached to a remote end of said supply line or riser.

24. The assembly of claim 20 wherein said riser tube comprises a pair of tube components secured by a coupler.

25. The assembly of claim 20 wherein an irrigation component is attached to the other end of said supply line or riser.

26. The assembly of claim 20 wherein said irrigation tube has a plurality of holes formed therein, some of which have said connector bushings bonded therein and others of which are closed by caps bonded over said holes.

27. The assembly of claim 20 wherein said irrigation tube and said connector bushing are constructed of polyethylene.

28. The assembly of claim 20 wherein said tubular connector includes a 90° elbow and said flexible supply line is inserted within a remote end of said tubular connector.

29. The assembly of claim 20 wherein said tubular connector includes a lower end portion and a pair of extensions transverse to said lower end portion, said pair of extensions having flexible supply lines inserted therein.
